(19) United States
(12) Patent Application Publication
(10) Pub. No.: US 2023/0281453 A1
(43) Pub. Date: Sep. 7, 2023

(54) CREATING METHOD OF CLASSIFICATION MODEL ABOUT HARD DISK EFFICIENCY PROBLEM, ANALYZING METHOD OF HARD DISK EFFICIENCY PROBLEM AND CLASSIFICATION MODEL CREATING SYSTEM OF HARD DISK EFFICIENCY PROBLEM

(71) Applicants: Inventec (Pudong) Technology Corporation, Shanghai (CN); INVENTEC CORPORATION, Taipei (TW)

(72) Inventors: Yi-Ju LIAO, Taipei (TW); JEN-YUAN CHANG, Taipei (TW); PO-HSIU CHEN, Taipei (TW); Hsieh-Liang TSAI, Taipei (TW)

(21) Appl. No.: 17/840,767

(22) Filed: Jun. 15, 2022

(30) Foreign Application Priority Data
Mar. 1, 2022 (CN) 202210206302.9

(51) Int. Cl. G06N 3/08; G06F 11/34

(52) U.S. Cl. CPC G06N 3/082; G06F 11/3476

(57) ABSTRACT

A creating method of a classification model about a hard disk efficiency problem comprising: by an analyzing device, performing: obtaining pieces of training data of hard disk devices and each of the pieces of training data including vibration parameters and provided with preset output results; inputting the pieces of training data to an artificial neural network model; training the artificial neural network model to make the artificial neural network model output the corresponding preset output results according to the vibration parameters of the pieces of training data; regarding the trained artificial neural network model as the classification model about the hard disk efficiency problem. By the classification model about the hard disk efficiency problem created by the aforementioned method, the reason of lowering hard disk efficiency is successfully found.

### CROSS-REFERENCE TO RELATED APPLICATIONS

This non-provisional application claims priority under 35 U.S.C. § 119(a) on patent No(s). 202210206302.9 filed in China on Mar. 1, 2022, the entire contents of which are hereby incorporated by reference.

### BACKGROUND

### 1. Technical Field

This disclosure relates to a creating method of a classification model, and particularly relates to a creating method of a classification model about a hard disk efficiency problem.

### 2. Related Art

As Internet rapidly develops, data processing amount is getting bigger and a needed number of servers is also getting bigger. When the server efficiency gets low, the data transmission of the Internet is affected and it would cause games to shut down, e-mail can't be sent normally or video conferencing is interrupted. How to improve the low server efficiency becomes an important issue.

Generally, the server efficiency relates to hard disk efficiency and the server is affected by the hard disk efficiency. If the hard disk efficiency gets low, the server efficiency gets low. Engineers usually find reason that causes the low hard disk efficiency inside the server by gradual manual analysis, but are unable to find the main reason which affects the hard disk efficiency and so are unable to effectively solve the problem of the low hard disk efficiency.

### SUMMARY

In light of the aforementioned description, the present disclosure provides a creating method of a classification model about a hard disk efficiency problem, an analysis method of a hard disk efficiency problem and a classification model creating system about a hard disk efficiency problem to find the main reason which affects the hard disk efficiency.

According to one or more embodiment of the present disclosure, a creating method of a classification model about a hard disk efficiency problem including: by an analyzing device, performing: obtaining a plurality of pieces of training data respectively corresponding to a plurality of hard disk devices, and each of the plurality of pieces of training data comprising a plurality of vibration parameters and provided with a plurality of preset output results each of which indicates one of a plurality of efficiency problems; inputting the plurality of pieces of training data to an artificial neural network model and computing a plurality of first output results respectively corresponding to the plurality of pieces of training data, wherein the artificial neural network model is provided with a weight set; performing a weight adjusting process according to differences between the plurality of first output results and the plurality of preset output results, with the weight adjusting process comprising: adjusting the weight set and generating a plurality of second output results using the artificial neural network model according to the adjusted weight set and the plurality of pieces of training data; if the plurality of second output results do not correspond to the plurality of preset output results, performing the weight adjusting process according to differences between the plurality of second output results and the plurality of preset output results; and if the plurality of second output results correspond to the plurality of preset output results, regarding the artificial neural network model with the adjusted weight set as the classification model about the hard disk efficiency problem.

According to one or more embodiment of the present disclosure, an analysis method of a hard disk efficiency problem including: obtaining the classification model about the hard disk efficiency problem created by the creating method according to claim 1; and inputting a piece of measurement data of a server hard disk to the classification model about the hard disk efficiency problem to generate a classifying result, wherein the classifying result indicates one of the plurality of efficiency problems

According to one or more embodiment of the present disclosure, a classification model creating system about a hard disk efficiency problem includes vibration parameter measurement components, an inputting device and an analyzing device. The vibration parameter measurement components are configured to measure vibration parameters respectively corresponding to each of hard disk devices. The inputting device is configured to receive preset output results corresponding to the hard disk devices each of which indicates one of efficiency problems. The analyzing device is connected to the vibration parameter measurement components and the inputting device and includes an artificial neural network model, with the following steps performed by the analyzing device: obtaining pieces of training data respectively corresponding to the hard disk devices, and each of the pieces of training data including the vibration parameters corresponding to a respective one of the hard disk devices and respectively provided with preset output results; inputting the pieces of training data to an artificial neural network model and operating first output results respectively corresponding to the pieces of training data, wherein the artificial neural network model is provided with a weight set; performing a weight adjusting process according to differences between the first output results and the preset output result, with the weight adjusting process including: adjusting the weight set and generating second output results by the artificial neural network model according to the adjusted weight set and the plurality of pieces of training data; if the second output results do not correspond to the preset output results, performing the weight adjusting process according to differences between the second output results and the preset output results; and if the second output results correspond to the preset output results, regarding the artificial neural network model with the adjusted weight set as the classification model about the hard disk efficiency problem.

In view of the above description, the creating method of the classification model about the hard disk efficiency problem and the classification model creating system about the hard disk efficiency problem disclosed by the present disclosure are based on the artificial neural network model, utilize the pieces of training data associated with the vibration parameters of the hard disk device to train the artificial neural network model and adjust the weight set of the artificial neural network model according to the differences between the preset output results and the output results outputted by the artificial neural network model according to the pieces of training data, thereby creating the classification model about the hard disk efficiency problem with high classification accuracy. In addition, the analysis method of the hard disk efficiency problem disclosed by the present disclosure inputs the piece of the measurement data of the abnormal hard disk inside the server and storage system to the aforementioned classification model about the hard disk efficiency problem and is able to determine the main reason of the low hard disk efficiency very well.

### BRIEF DESCRIPTION OF THE DRAWINGS

FIG. 1 illustrates a functional block diagram of a classification model creating system about a hard disk efficiency problem according to one embodiment of the present disclosure.

FIG. 2 illustrates a flowchart of a creating method of a classification model about a hard disk efficiency problem according to one embodiment of the present disclosure.

FIG. 3 illustrates a schematic diagram of an artificial neural network model according to one embodiment of the present disclosure.

FIG. 4 illustrates a schematic diagram of performing environment of an analysis method of a hard disk efficiency problem according to one embodiment of the present disclosure.

FIG. 5 illustrates a flowchart of an analysis method of a hard disk efficiency problem according to one embodiment of the present disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown to simplify the drawings.

It is to be understood that although the terms ‘first’, ‘second’ and so on, may be used herein to describe various elements, components, regions and/or parts, these elements, components, regions and/or parts should not be limited by these terms. These terms are used only for the purpose of distinguishing one element, component, region and/or part from another element, component, region and/or part.

In addition to, the terms “comprise” and/or “include” are referred to the existence of features, regions, structures, steps, operation and/or components, but are not to exclude the existence or adding of one or more of the other features, regions, structures, steps, operation, components and/or combination thereof.

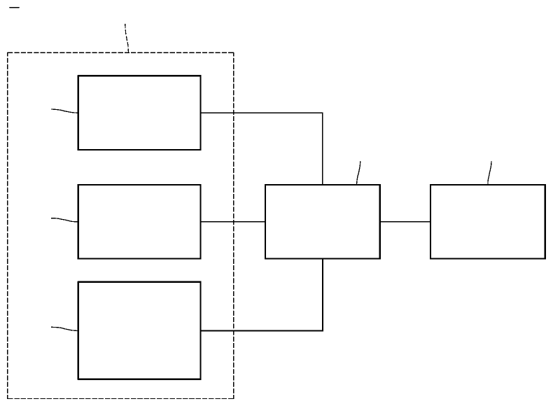

Please refer to FIG. 1, which illustrates a functional block diagram of a classification model creating system about a hard disk efficiency problem according to one embodiment of the present disclosure. As illustrated in FIG. 1, the classification model creating system 1 about the hard disk efficiency problem includes vibration parameter sensors 11, an analyzing device 12 and an inputting device 13. The analyzing device 12 and the inputting device 13 are connected to the vibration parameter sensors 11.

Hard disk device as follows is referred as respective hard disk device loaded in a server. One server may load a plenty of hard disk devices, and may load four hard disk devices, eight hard disk devices or twelve hard disk devices according to its capacity. Said vibration parameter sensors 11 are configured to measure the values of vibration parameters of each of the hard disk devices. Specifically, the vibration parameter sensors 11 may include at least two of a 3-axis accelerometer 111, a sound pressure meter 112 and a resonance frequency spectrum analyzer 113. The 3-axis accelerometer 111 is configured to measure values of acceleration and values of angular acceleration of the hard disk devices. The sound pressure meter 112 is configured to measure values of sound pressure of the hard disk devices. The resonance frequency spectrum analyzer 113 may be implemented by a hard disk I/O efficiency evaluation tool (IO meter) or a frequency spectrum analyzer, and is configured to analyze values of resonance frequency of the hard disk devices. Namely, said vibration parameters may include at least two of the acceleration, the angular acceleration, the sound pressure and the resonance frequency.

The inputting device 13 may be a user input interface. The user input interface may be a keyboard and mouse set or a touch display panel for example, and the aforementioned description is just an example and is not limited thereto. The inputting device 13 is configured to receive preset output results corresponding to each of the hard disk devices, each of the preset output results indicates one of efficiency problems, such as an acceleration problem, a rotation problem, a sound pressure problem and a frequency problem. In other words, a user inputs the preset output results of each of the hard disk devices to the analyzing device 12 by the inputting device 13. Specifically, said efficiency problems respectively correspond to said vibration parameters. For example, the efficiency problems may include the acceleration problem, the rotation problem, the sound pressure problem and the frequency problem respectively corresponding to the acceleration, the angular acceleration, the sound pressure and the resonance problem. The preset output results may also be determined by an outside processor or the user according to fail conditions corresponding to each of the vibration parameters and are inputted to the analyzing device 12 by the inputting device 13. Specifically, if the measured value of the vibration parameter meets the fail condition, the preset output result is set as the efficiency problem corresponding to the vibration parameter. For example, if the measured value of the acceleration meets the fail condition, the preset output result is set as the acceleration problem.

Taking one example of setting values of the fail conditions, the fail conditions for the hard disk with 1 TB storage capacity or 2 TB storage capacity are set as follows: the frequency being 300 Hz/900 Hz, the sound pressure being greater than 114 dB and the angular acceleration being greater than grad/s2; the fail conditions for the hard disk with 10 TB storage capacity are set as follows: the frequency being 300 Hz/900 Hz, the sound pressure being greater than 108 dB, the acceleration being greater than 0.2 m/s² and the angular acceleration greater than brad/s². Among the vibration parameters of the fail conditions, the frequency of the fail conditions is a resonance frequency of a server case and a fan.

The analyzing device 12 may be a microcontroller, a graphics processing unit or the other electronic device with functions of processing and storing data, but is not limited thereto. The analyzing device 12 receives the values of the vibration parameters and the preset output results of each of the hard disk devices and regards them as an input of an artificial neural network model to train the artificial neural network model, and regards the trained artificial neural network model as the classification model about the hard disk efficiency problem. The detailed training process of the artificial neural network model is described in the latter paragraphs.

In one embodied aspect, the vibration parameter sensors 11, the analyzing device 12 and the inputting device 13 are integrated into one electronic apparatus. In another embodied aspect, the analyzing device 12 and the inputting device 13 are integrated into one electronic apparatus and are independent of the vibration parameter sensors 11 and are electrically connected or communicatively connected to the vibration parameter sensors 11. In yet another embodied aspect, the vibration parameter sensors 11, the analyzing device 12 and the inputting device 13 are independently disposed and the analyzing device 12 may be disposed on edge or cloud and is communicatively connected to the vibration parameter sensors 11 and the inputting device 13.

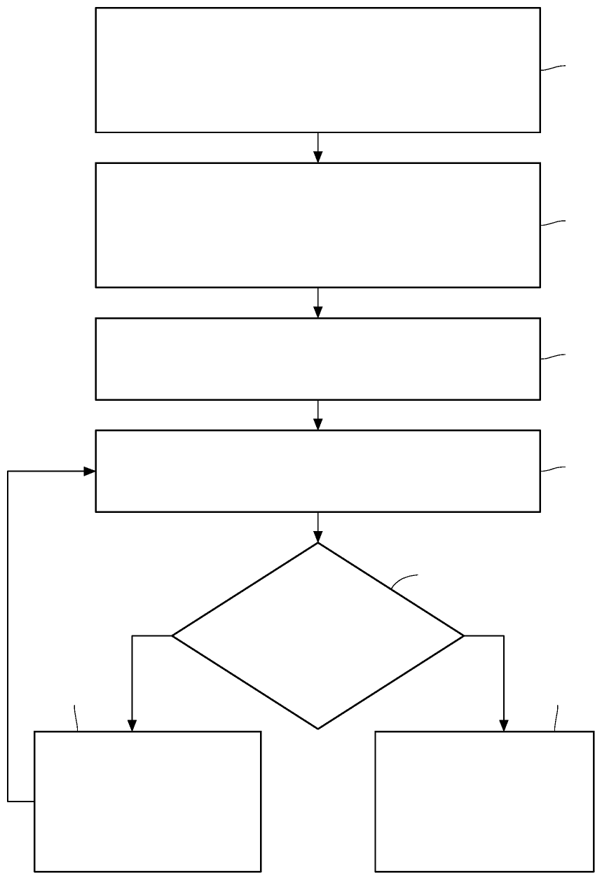

Please refer to FIG. 1 and FIG. 2, wherein FIG. 2 illustrates a flowchart of a creating method of a classification model about a hard disk efficiency problem according to one embodiment of the present disclosure. As illustrated in FIG. 2, the creating method of the classification model about the hard disk efficiency problem includes step S11˜step S17. The creating method of the classification model about the hard disk efficiency problem shown in FIG. 2 may be applicable to the classification model creating system 1 about the hard disk efficiency problem shown in FIG. 1. For example, the step S11˜step S17 would be explained by the operation of the classification model creating system 1 about the hard disk efficiency problem shown in FIG. 1 as follows.

Step S11: obtaining pieces of training data respectively corresponding to the hard disk devices, and each of the pieces of training data comprising vibration parameters and provided with preset output results each of which indicates one of efficiency problems. As described above, the analyzing device 12 obtains the values of the vibration parameters from the vibration parameter sensors 11 which perform the measuring process on each of the hard disk devices, such as the values of the acceleration, the angular acceleration, the sound pressure and the resonance frequency. The analyzing device 12 may receive the preset output results of each of the hard disk devices from the inputting device 13. In one embodied aspect, the analyzing device 12 may control the vibration parameter sensors 11 to perform the measuring process on each of the hard disk devices and to transmit measuring results back to the analyzing device 12. In another aspect, the vibration parameter sensors 11 may be controlled by a user or other control devices to perform the measuring process on each of hard disk devices and to transmit measuring results to the analyzing device 12. In additions, in step S11, the analyzing device 12 may also control the vibration parameter sensors 11 to perform the measuring process on the server case or the fan to obtain the values of the vibration parameters, for example, the values of the resonance frequency of the server case or the fan, which may also be used as the training data.

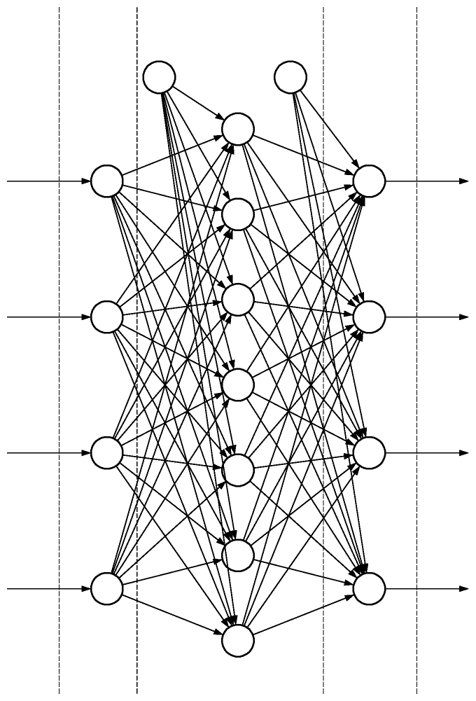

Step S12: inputting the pieces of training data to the artificial neural network model and computing first output results respectively corresponding to the pieces of training data by the analyzing device 12, wherein the artificial neural network model is provided with a weight set. Specifically, as illustrated in FIG. 3, the artificial neural network model includes an input layer IN, a hidden layer HL and an output layer OUT, and the weight set includes weights of connection between neural units. Specially, the activation function of the artificial neural network model is a normalized function (Softmax), the normalized function after differential operation is a continuous function. When an input value is between 0 and 1, a risk of deactivating the normalized function can be lowered significantly and a rate of generating false result may be also lowered significantly. The analyzing device 12 inputs each of the pieces of training data to the input layer IN, and each of the pieces of training data passes through the input layer IN and the hidden layer HL and the first output results are outputted from the output layer OUT. For example, the input layer IN has 4 input points x1˜x4 and the output layer OUT has 4 output points y1˜y4. For example, 4 input points x1˜x4 respectively represent the acceleration, the angular acceleration, the sound pressure and the resonance frequency, output points y1˜y4 respectively represent the acceleration problem, the rotation problem, the sound pressure problem and the frequency problem and the acceleration, the angular acceleration, the sound pressure and the resonance frequency of each of the pieces of training data respectively are inputted from 4 input points x1˜x4. The artificial neural network model calculates the shortest path of each of the pieces of training data and generates the corresponding first output result, wherein the first output result indicates that one of 4 output points y1˜y4 is a terminal point of the shortest path, the output value of the terminal point is 1 and the values of the other output points are 0. It is specially explained that, FIG. 3 merely exemplarily illustrates the number of the input points and the output points but does not intend to limit the present disclosure.

Step S13: adjusting the weight set by the analyzing device 12 according to differences between said first output results and said preset output results. Specifically, the analyzing device 12 utilizes a cost function to respectively calculate differences between said first output results and said preset output results, and the differences are served as a basis for adjusting the weight set. The analyzing device 12 utilizes a back propagation algorithm and a gradient descent algorithm to adjust the weight set. Specifically, the cost function is a cross entropy. When the aforementioned differences is too large, the punishment of the artificial neural network model given by the cross entropy is greater and the accuracy of the artificial neural network model in a training period is increased.

Step S14: generating second output results by the analyzing device 12 using the artificial neural network model according to the adjusted weight set and said pieces of training data. Specifically, after step S13, the weight set of the artificial neural network model is adjusted and the analyzing device 12 inputs the pieces of training data to the artificial neural network model with the adjusted weight set again to generate new output results (second output results).

Step S15: determining whether the second output results correspond to the preset output results or not by the analyzing device 12. Specifically, the analyzing device 12 utilizes the cost function to respectively calculate differences between the second output results and the preset output results. The cost function as described above may be the cross entropy. When the differences are greater than a preset threshold value, it indicates that said second output results don't correspond to the preset output results and the analyzing device 12 performs step S16; When the differences are not greater than the preset threshold value, it indicates that said second output results correspond to the preset output results and the analyzing device 12 performs step S17. The actual value of the preset threshold value is set according to actual requirements and the present disclosure doesn't limit the actual value of the preset threshold value.

Step S16: adjusting the weight set according to the differences between the second output results and the preset output results by the analyzing device 12. Specifically, the analyzing device 12 utilizes said differences between said second output results and said preset output results calculated using the cost function as the basis for adjusting the weight set, and utilizes the back propagation algorithm and the gradient descent algorithm to adjust the weight set, and then performs step S14 and step S15 again. In other words, the analyzing device 12 can repeatedly performs step S14—step S16 to adjust the weight set of the artificial neural network model until the differences obtained by the calculation of the cost function are not greater than the preset threshold value. Specifically, the aforementioned step of adjusting the weight set and generating second output results according to the adjusted weight set and the pieces of training data may be seen as a weight adjusting process, and the generated second output results and the adjusted weight set for each round are different.

Step S17: regarding the artificial neural network model with the adjusted weight set as the classification model about the hard disk efficiency problem by the analyzing device 12. If said second output results correspond to the preset output results, it indicates that the training of the artificial neural network model with the adjusted weight set is finished. Hence, in this step, the analyzing device 12 regards the trained artificial neural network model as the classification model about the hard disk efficiency problem, which may be configured to conduct a classifying process of the hard disk efficiency problem on new measurement data.

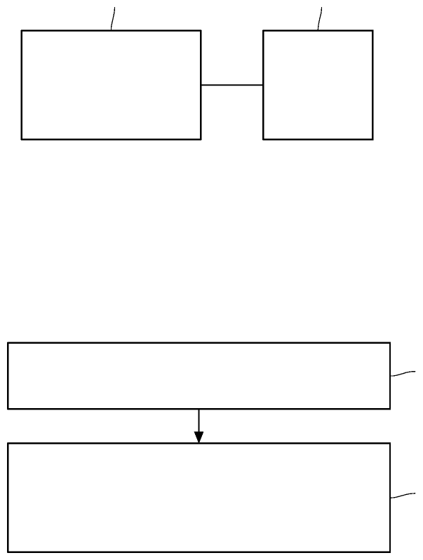

Please refer to FIG. 4 and FIG. 5, which illustrate a schematic diagram of performing environment of an analysis method of a hard disk efficiency problem according to one embodiment of the present disclosure and a flowchart of an analysis method of a hard disk efficiency problem according to one embodiment of the present disclosure. As illustrated in FIG. 4 and FIG. 5, the performing environment corresponding to the analysis method of the hard disk efficiency problem may include the classification model creating system 1 about the hard disk efficiency problem and a computer system 2, wherein the computer system 2 may be communicatively connected to the classification model creating system 1 about the hard disk efficiency problem. The classification model creating system 1 about the hard disk efficiency problem may provide the classification model about the hard disk efficiency problem as illustrated in FIG. 1, and the related details thereof are described in the aforementioned paragraphs and are not described again. The computer system 2 includes a processor. The processor inputs a piece of measurement data of an abnormal server hard disk to the classification model about the hard disk efficiency problem to obtain a classification result. The processor is a microcontroller, a graphics processing unit or other electronic devices with functions of processing and storing data, but is not limited thereto. In the present embodiment, the computer system 2 which performs the classification model about the hard disk efficiency problem and the analyzing device which creates the classification model about the hard disk efficiency problem are different devices. In another embodiment, the computer system 2 which performs the classification model about the hard disk efficiency problem and the analyzing device which creates the classification model about the hard disk efficiency problem are the same device.

Here, the analysis method of the hard disk efficiency problem is explained and includes step S21˜step S22. Step S21: obtaining the classification model about the hard disk efficiency problem as shown in FIG. 2. Specifically, the classification model about the hard disk efficiency problem may be implemented by software. In one embodied aspect, the software is stored on a server or an outside hard disk, and the server or the outside hard disk may be connected to the processor of the computer system 2. The server transmits the classification model about the hard disk efficiency problem to the processor of the computer system 2 by internet, or the outside hard disk transmits the classification model about the hard disk efficiency problem to the processor of the computer system 2 by using a transmission cable to connect to the computer system 2. In other words, the processor of the computer system 2 may access and execute the classification model about the hard disk efficiency problem from the server or the outside hard disk. In another embodied aspect, the software of the classification model about the hard disk efficiency problem is stored in the storage device of the computer system 2, and the processor of the computer system 2 reads and executes the software of the classification model about the hard disk efficiency problem.

Step S22: inputting the piece of measurement data of the abnormal server hard disk to the classification model about the hard disk efficiency problem by the computer system 2 to obtain the classifying result, wherein the classifying result indicates one of the efficiency problems and the efficiency problems are associated with two or more of the vibration parameters. For example, the efficiency problems may include the acceleration problem, the rotation problem, the sound pressure problem and the frequency problem which are respectively associated with the acceleration, the angular acceleration, the sound pressure and the resonance frequency. Specifically, the computer system 2 may utilize the classification model about the hard disk efficiency problem to determine the efficiency problem which affects the serve significantly, and the efficiency problem which affects the serve significantly is served as the main reason of the low hard disk efficiency.

In one embodiment of the present disclosure, the creating method of the classification model about the hard disk efficiency problem, the analysis method of the hard disk efficiency problem and the classification model creating system about the hard disk efficiency problem perform an analyzing test on the hard disks loaded on the server to increase the reliability of the server. The server is suitable for artificial intelligence computing and edge computing, and may also be served as a 5G server, a cloud server or an Internet of vehicle server.

In view of the above description, the creating method of the classification model about the hard disk efficiency problem and the classification model creating system about the hard disk efficiency problem disclosed by the present disclosure are based on the artificial neural network model, utilize the pieces of training data associated with the vibration parameters of the hard disk device to train the artificial neural network model and adjust the weight set of the artificial neural network model according to the differences between the preset output results and the output results outputted by the artificial neural network model according to the pieces of training data, thereby creating the classification model about the hard disk efficiency problem with high classification accuracy. In addition, the analysis method of the hard disk efficiency problem disclosed by the present disclosure inputs the piece of the measurement data of the abnormal hard disk inside the server and storage system to the aforementioned classification model about the hard disk efficiency problem and is able to determine the main reason of the low hard disk efficiency very well.

What is claimed is:

1. A creating method of a classification model about a hard disk efficiency problem comprising: by an analyzing device, performing:
obtaining a plurality of pieces of training data respectively corresponding to a plurality of hard disk devices, and each of the plurality of pieces of training data comprising a plurality of vibration parameters and provided with a plurality of preset output results each of which indicates one of a plurality of efficiency problems;
inputting the plurality of pieces of training data to an artificial neural network model and computing a plurality of first output results respectively corresponding to the plurality of pieces of training data, wherein the artificial neural network model is provided with a weight set;
performing a weight adjusting process according to differences between the plurality of first output results and the plurality of preset output results, with the weight adjusting process comprising:
adjusting the weight set and generating a plurality of second output results using the artificial neural network model according to the adjusted weight set and the plurality of pieces of training data;
if the plurality of second output results do not correspond to the plurality of preset output results, performing the weight adjusting process according to differences between the plurality of second output results and the plurality of preset output results; and
if the plurality of second output results correspond to the plurality of preset output results, regarding the artificial neural network model with the adjusted weight set as the classification model about the hard disk efficiency problem.

2. The creating method of the classification model about the hard disk efficiency problem according to claim 1, wherein the plurality of vibration parameters comprises two or more of acceleration, angular acceleration, sound pressure and resonance frequency.

3. The creating method of the classification model about the hard disk efficiency problem according to claim 1, wherein adjusting the weight set is performed by a back propagation algorithm and a gradient descent algorithm.

4. The creating method of the classification model about the hard disk efficiency problem according to claim 1, wherein the differences between the plurality of first output results and the plurality of preset output results are generated by calculation using a cost function, and the differences between the plurality of second output results and the plurality of preset output results are generated by calculation using the cost function which is a cross entropy.

5. The creating method of the classification model about the hard disk efficiency problem according to claim 1, wherein an activation function of the artificial neural network model is a normalized function.

6. An analyzing method of a hard disk efficiency problem comprising performing by a computer system:
obtaining the classification model about the hard disk efficiency problem created by the creating method according to claim 1; and
inputting a piece of measurement data of a server hard disk to the classification model about the hard disk efficiency problem to generate a classifying result, wherein the classifying result indicates one of the plurality of efficiency problems.

7. An analyzing method of a hard disk efficiency problem comprising performing by a computer system:
obtaining the classification model about the hard disk efficiency problem created by the creating method according to claim 2; and
inputting a piece of measurement data of a server hard disk to the classification model about the hard disk efficiency problem to generate a classifying result, wherein the classifying result indicates one of the plurality of efficiency problems.

8. An analyzing method of a hard disk efficiency problem comprising performing by a computer system:
obtaining the classification model about the hard disk efficiency problem created by the creating method according to claim 3; and
inputting a piece of measurement data of a server hard disk to the classification model about the hard disk efficiency problem to generate a classifying result, wherein the classifying result indicates one of the plurality of efficiency problems.

9. An analyzing method of a hard disk efficiency problem comprising performing by a computer system:
obtaining the classification model about the hard disk efficiency problem created by the creating method according to claim 4; and
inputting a piece of measurement data of a server hard disk to the classification model about the hard disk efficiency problem to generate a classifying result, wherein the classifying result indicates one of the plurality of efficiency problems.

10. An analyzing method of a hard disk efficiency problem comprising performing by a computer system:
obtaining the classification model about the hard disk efficiency problem created by the creating method according to claim 5; and
inputting a piece of measurement data of a server hard disk to the classification model about the hard disk efficiency problem to generate a classifying result, wherein the classifying result indicates one of the plurality of efficiency problems.

11. A classification model creating system of a hard disk efficiency problem comprising:
a plurality of vibration parameter measurement components configured to measure a plurality of vibration parameters respectively corresponding to each of a plurality of hard disk devices;
an inputting device configured to receive a plurality of preset output results corresponding to the plurality of hard disk devices each of which indicates one of a plurality of efficiency problems; and
an analyzing device connected to the plurality of vibration parameter measurement components and the inputting device and comprising an artificial neural network model, with the following steps performed by the analyzing device:
obtaining a plurality of pieces of training data respectively corresponding to a plurality of hard disk devices, and each of the plurality of pieces of training data comprising a plurality of vibration parameters corresponding to a respective one of the plurality of hard disk devices and respectively provided with the plurality of preset output results;
inputting the plurality of pieces of training data to an artificial neural network model and operating a plurality of first output results respectively corresponding to the plurality of pieces of training data, wherein the artificial neural network model is provided with a weight set;
performing a weight adjusting process according to differences between the plurality of first output results and the plurality of preset output result, with the weight adjusting process comprising:
adjusting the weight set and generating a plurality of second output results by the artificial neural network model according to the adjusted weight set and the plurality of pieces of training data;
if the plurality of second output results do not correspond to the plurality of preset output results, performing the weight adjusting process according to differences between the plurality of second output results and the plurality of preset output results; and
if the plurality of second output results correspond to the plurality of preset output results, regarding the artificial neural network model with the adjusted weight set as a classification model about the hard disk efficiency problem.

12. The classification model creating system of the hard disk efficiency problem according to claim 11, wherein the plurality of vibration parameters comprises two or more of acceleration, angular acceleration, sound pressure and resonance frequency.

13. The classification model creating system of the hard disk efficiency problem according to claim 11, wherein adjusting the weight set is performed by a back propagation algorithm and a gradient descent algorithm.

14. The classification model creating system of the hard disk efficiency problem according to claim 11, wherein the differences between the plurality of first output results and the plurality of preset output results are generated by calculation using a cost function, and the differences between the plurality of second output results and the plurality of preset output results are generated by calculation using the cost function which is a cross entropy.
